(19) United States
(12) Patent Application Publication
(10) Pub. No.: US 2009/0134028 A1
(43) Pub. Date: May 28, 2009

(54) Method of Estimating Effect of Test Chemical on Living Organisms

(75) Inventors: Hidenori Yamanaka, Saitama (JP); Yoshikuni Yakabe, Saitama (JP); Yoshihisa Sudo, Saitama (JP); Kayo Sumida, Osaka (JP); Koji Nakayama, Ibaraki (JP)

Correspondence Address: BIRCH STEWART KOLASCH & BIRCH, PO BOX 747, FALLS CHURCH, VA, 22040-0747, US

(73) Assignees: Chemicals Evaluation and Research Institute, Tokyo (JP); Sumitomo Chemical Co., Ltd., Tokyo (JP); Mitsubishi Chemical Safety Institute Ltd., Tokyo (JP)

(21) Appl. No.: 11/992,421

(22) PCT Filed: Sep. 22, 2006
(86) PCT No.: PCT/JP2006/318826

§ 371 Date: Jan. 29, 2009

(30) Foreign Application Priority Data
Sep. 22, 2005 (JP) 2005-276814

(51) Int. Cl. B01D 57/02

(52) U.S. Cl. 204/461

(57) ABSTRACT

A method of predicting an effect of a test chemical on living organisms, which comprises:
a step of administering a plurality of chemicals whose effects on living organisms are known, to respective chemical dosed groups, administering a test chemical to a test chemical dosed group, collecting proteins from each group after a definite period of time, separating the proteins by two-dimensional gel electrophoresis, measuring the signal intensities of spots of the proteins and modified proteins formed therefrom, and calculating a signal intensity ratio of at least two spots, and
a step of comparing the signal intensity ratio of test chemical dosed group with the signal intensity ratio of each chemical dosed group.

### TECHNICAL FIELD

The present invention relates to a method of predicting an effect of a test chemical on living organisms, by comparing the proportions of proteins of different modifications produced when a test chemical has been administered to a living body, with the proportions of proteins produced when other chemical has been administered. Proteins of different modifications are produced in a living body by a processing such as post-translational modifications, truncation or the like.

### BACKGROUND ART

It is known that the expression of proteins in living body is associated with the physiological state of cell. In the comparative proteome analysis, the proteins expressed in a sample are first separated by two-dimensional gel electrophoresis; then, the signal intensities given by the spots of separated proteins are compared; and the amounts of proteins expressed are compared.

Proteins are translated based on the genetic information of RNA, after which they may be subjected to post-translational modifications such as phosphorylation, glycosylation or the like. The proteins modified by post-translational modifications or the like differ slightly in isoelectric point depending upon the kind and modification sites, the number of modification groups, etc. As a result, the modified proteins, when separated by two-dimensional gel electrophoresis, are detected as a series of continuous spots. Comparative analysis of not only protein expression level but also proteins subjected to post-translational modifications are important in order to known the state of cell.

In recent years, the analytical method of proteins using a mass spectrometer has seen a rapid development, and there were proposed a method of determining glycosylation sites using a mass spectrometer (non-patent literatures 1 and 2), and a method of identifying phosphorylated peptides comprehensively (non-patent literature 3). The methods described in the non-patent literatures 1 to 3 have made possible the comprehensive identification of phosphorylated proteins and the identification of glycosylation sites.

As the technique of quantitative analysis of phosphorylated proteins, a method is known which uses stable isotope labeled amino acids. This method comprises culturing cells in a medium containing stable isotope labeled amino acids, then chromatographic enrichment of phosphorylated proteins present in the cells, and analyzing them using a mass spectrometer. For purification of the phosphorylated proteins, there is used, for example, affinity chromatography using a anti-phosphotyrosine antibody. In this method, however, only the information regarding the increase or decrease of phosphorylated proteins formed from proteins can be obtained. Therefore, it has heretofore been impossible to comprehensively determine or compare the increase or decrease of the modified proteins in the distinct proteins by a processing such as post-translational modifications, truncation or the like and of the original proteins per se to be subjected to a processing.
Non-patent literature 1: Anal. Chem. 1999, 71, 1431-1440 (page 1433)
Non-patent literature 2: Nature Biotechnology 2003, 21, 667-672 (page 672)
Non-patent literature 3: Nature Biotechnology 2001, 19, 379-382 (page 382)

### DISCLOSURE OF THE INVENTION

### Task to be Achieved by the Invention

When proteins produced by translation of gene are separated by two-dimensional gel electrophoresis, there are cases in which a series of spots are detected on the gel used for electrophoresis. In such a case, there is conducted an analysis including the changes of expression amounts of proteins per se and the changes of expression amounts caused by post-translation modification or processing. There are conventional studies which focused only on the proteins modified by post-translational modifications or processing. However, there has been made no comprehensive analysis on the expression changes of modified proteins in the distinct proteins.

The present invention aims at providing a method of predicting an effect of a test chemical on living organisms, by comprehensively analyzing the expression amounts of proteins produced by translation and modified proteins thereof, formed by post-translational modifications or truncation. The effect on living organisms includes, for example, the drug effect, toxicity and carcinogenicity of chemical.

### Means for Achieving the Task

The present inventors attempted measurement of the expression ratio of modified proteins by quantitative proteomic analysis employing two-dimensional gel electrophoresis, using multiple spots of modified proteins derived from distinct proteins, produced by a processing such as post-translational modifications (e.g. phosphorylation or glycosylation), truncation or the like. By investigation of the result, it was found that, by comparing the above-mentioned expression ratio of modified proteins between chemicals whose effect on living organisms are known and a test chemical, the effect of the test chemical on living organisms could be predicted. The present invention has been completed based on the finding.

The present invention, which has achieved the above task, is as described below.

[1] A method of predicting an effect of a test chemical on living organisms, which comprises:

a step of administering a plurality of chemicals whose effects on living organisms are known, to respective chemical dosed groups, collecting proteins from each chemical dosed group after a definite period of time, separating the proteins by two-dimensional gel electrophoresis, measuring signal intensities of at least two spots selected from a plurality of spots of one separated protein and one or more separated modified proteins thereof formed by post-translational modifications or by truncation, calculating a signal intensity ratio of the at least two spots, and accumulating such a signal intensity ratio,

a step of administering a test chemical to a test chemical dosed group, collecting proteins from the test chemical dosed group after a definite period of time, separating the proteins by two-dimensional gel electrophoresis, measuring signal intensities of at least two spots selected from a plurality of spots of one separated protein and one or more separated modified proteins thereof formed by post-translational modifications or by truncation, and calculating a signal intensity ratio of the at least two spots, and

a step of comparing at least one signal intensity ratio calculated in the test chemical dosed group, with the signal intensity ratio calculated from the spots of the corresponding protein or the modified proteins thereof in each chemical dosed group.

[2] A method of predicting an effect of a test chemical on living organisms, which comprises:

a step of administering a vehicle to a vehicle control group, collecting proteins from the vehicle control group after a definite period of time, separating the proteins by two-dimensional gel electrophoresis, and measuring signal intensities (α_{c}) of at least two spots selected from a plurality of spots of one separated protein and one or more separated modified proteins thereof formed by post-translational modifications or by truncation,

a step of dissolving a plurality of chemicals whose effect on living organisms are known, in said vehicle to prepare chemical solutions, administering the chemical solutions to respective chemical dosed groups, collecting proteins from each chemical dosed group after a definite period of time, separating the proteins by two-dimensional gel electrophoresis, measuring signal intensities (αₓ) of at least two spots selected from a plurality of spots of one separated protein and one or more separated modified proteins thereof formed by post-translational modifications or by truncation, dividing, for each of the plurality of spots, the signal intensity (αₓ) by the signal intensity (α_{c}) of vehicle control group to calculate a corrected signal intensity (αₓ/α_{c}), calculating a ratio of corrected signal intensities (αₓ/α_{c}) between the at least two spots selected from a plurality of spots, and accumulating such a ratio,

a step of dissolving a test chemical in said vehicle to prepare a test chemical solution, administering the test chemical solution to a test chemical dosed group, collecting proteins from the test chemical dosed group after a definite period of time, separating the proteins by two-dimensional gel electrophoresis, measuring, for at least two spots selected from a plurality of spots of at least one separated protein and one or more separated modified proteins thereof formed by post-translational modifications or by truncation, their signal intensities (α_{E}), dividing, for each of the plurality of spots, the signal intensity (α_{E}) by the signal intensity (α_{c}) of vehicle control group to calculate a corrected signal intensity (α_{E}/α_{c}), and calculating a ratio of corrected signal intensities (α_{E}/α_{c}) between the at least two spots selected from a plurality of spots, and a step of comparing at least one ratio of corrected signal intensities (α_{E}/α_{c}) calculated in the test chemical dosed group, with the ratio of corrected signal intensities (αₓ/α_{c}) calculated from the spots of the corresponding protein or the modified proteins thereof in each chemical dosed group.

[3] A method of predicting an effect of a test chemical on living organisms according to [2], wherein, in the step of comparing the ratio of corrected signal intensities calculated in the test chemical dosed group, with the ratio of corrected signal intensities calculated in each chemical dosed group, the comparison of the ratios of corrected signal intensities between the test chemical dosed group and the chemical dosed group is conducted by dividing the chemical dosed group into at least two groups based on the effect of chemical on living organisms, making a significant test between the groups to select a modified protein formed by characteristic modification, and using the corrected signal intensity of the modified protein in the comparison.
[4] A method of predicting an effect of a test chemical on living organisms according to any of [1] to [3], wherein the effect on living organisms is carcinogenicity, drug effect or toxicity.

### EFFECT OF THE INVENTION

In the present invention, the expression amount ratios of proteins or modified proteins derived from an original protein are measured, and a comparison is made between chemical dosed groups whose effects on living organisms are known and a test chemical dosed group. By this comparison, the effect (e.g. drug effect, toxicity and carcinogenicity) of the test chemical on living organisms can be predicted.

In the prediction method of the present invention, it is not necessary to conduct an animal test over a long period of time in order to evaluate the effect of a test chemical on living organisms; and the effect of a test chemical on living organisms can be predicted accurately by an animal test of short period of about 1 to 90 days. Therefore, the present invention is useful for screening of chemical.

### BRIEF DESCRIPTION OF THE DRAWINGS

FIG. 1 is a graph showing the relation between the number of spots derived from an original protein and the number of proteins where the spots of the number are detected, obtained in Example 1.

FIG. 2 is a graph showing the relation between the number of data sets used in prediction of carcinogenicity and the obtained prediction rate, obtained in Example 1.

FIG. 3 is a graph showing the total scores of carcinogenic substances, calculated in Example 1.

FIG. 4 is a graph showing the total scores of carcinogenic substances, calculated in Example 1.

FIG. 5 is a graph showing the total scores of non-carcinogenic substances, calculated in Example 1.

FIG. 6 is a figure by a scanner, showing the positions on reference gel, of the data sets of highest prediction rate, obtained in Example 1.

FIG. 7 is a figure by a scanner, showing the positions on reference gel, of the data sets of highest prediction rate, obtained in Example 3.

### BEST MODE FOR CARRYING OUT THE INVENTION

The method of the present invention, of predicting an effect of a test chemical on living organisms is carried out by the following procedure.

First, there are prepared a solution of a chemical whose effect on living organisms is known, dissolved in a vehicle and a solution of a test chemical dissolved in the same vehicle. Then, the chemical solution is administered to a chemical dosed group and the test chemical solution is administered to a test chemical dosed group. Further, the vehicle used in preparation of the chemical solution and the test chemical solution is administered to a vehicle control group. After a definite period of time, a tissue of experimental animal is collected from each group.

The number of chemicals whose effects on living organisms are known, administered to the chemical dosed group is at least two including a chemical having an effect on living organisms and a chemical having no effect. In order to predict the effect on living organisms at a higher accuracy, the number of chemicals is preferably at least 5, more preferably at least 10.

The administration of chemical (whose effect on living organisms is known) and subsequent data analysis and data accumulation (described later) may be conducted simultaneously with the administration of test chemical and vehicle and subsequent data analysis. The administration of chemical (whose effect on living organisms is known) and subsequent data analysis and data accumulation may be conducted prior to the administration of test chemical, or may be conducted after the administration of test chemical and vehicle and subsequent data analysis.

The administration of the chemical solution, the test chemical solution and the vehicle to respective groups is conducted at a frequency of, for example, one to several times per day or given time length (preferably once a day), for a given period of time (about 1 to 90 days) continuously.

As to the method of administration of each solution or vehicle to each group, there is no particular restriction, and wide-use methods such as oral administration, intraperitoneal administration, intravenous administration and the like can be employed.

As the experimental animal, there can be used rat, mouse, dog, monkey, guinea pig, rabbit, etc.

As to the period from the start of administration of the chemical solution, the test chemical solution or the vehicle to the collection of the tissues of experimental animals of each group, there is no particular restriction. However, the period is, for example, about 1 to 90 days and, preferably, about 1 to 28 days for a rapid test. The tissues of experimental animals, to be collected include organs, blood, urine, etc.

Proteins are extracted from the collected tissues of experimental animals and purified as necessary, after which a sample is prepared for use in two-dimensional gel electrophoresis. As the method for sample preparation, a conventional preparation method or extraction method can be appropriately selected and used.

For example, the cells collected from each group are first subjected to an ultrasonic treatment; a mechanical treatment by Downce type homogenizer, Potter-Elvehjem homogenizer, French press, or the like; and a chemical treatment by surfactant, enzyme or the like. By these treatments is prepared a cell lysate. The cell lysate can be subjected per se to a first-dimensional gel electrophoresis. When a particular cell portion such as nucleus, mitochondria, cell membrane or the like is used as a sample, a required organelle is isolated from the cell lysate by differential centrifugation or other known method. Also, it is possible to use a prefractionation technique such as liquid isoelectric point focussing.

In the two-dimensional gel electrophoresis, the range of isoelectric point (pI) in first-dimensional gel electrophoresis can be set by selecting, from commercial various IPG (immobilized pH gradient) Strips (products of GE Healthcare UK Ltd. Buckinghamshire, UK etc.), one having a separation pH range suitable for the sample.

The method of sample addition to gel in first-dimensional gel electrophoresis can be selected from a cup loading method; a paper loading method; a method of adding a swelling solution containing a sample; etc.

Second-dimensional gel electrophoresis can be conducted by appropriately selecting any of a vertical electrophoresis system, a horizontal electrophoresis system, etc. As the gel, there can be used a commercial precast acrylamide gel, a self-made acrylamide gel, etc. The gel can be a homogeneous gel or a gradient gel.

After the electrophoresis, the detection of proteins on gel can be conducted by using silver staining (used for SDS gel), Coomassie staining, etc. When, before electrophoresis, the sample has been subjected to fluorescent staining, a fluorescent scanner (CCD camera type), etc. can be used for detection of proteins. Also, when there is used a sample (proteins) labeled in vivo with a radioactive isotope such as ³⁵S, ¹⁴C, ³H, ³²P or the like, autoradiography or fluorography can be used. In the detection of proteins by autoradiography, the gel is dried and then the positions of proteins on gel are recorded using an X-ray film or a phosphor screen. In using fluorography, the gel is allowed to take in a fluorescent substance, prior to its drying.

After the detection of proteins by the above-mentioned method, the image of proteins on gel is captured as data using a scanner or the like, and each spot is detected using an image analysis software. Each spot is measured for its signal intensity, whereby the quantitative determination of proteins is made. As the image analysis software used, there can be mentioned, for example, PDQuest (Bio-Rad Laboratories, Inc. CA, USA), GELLAB II+ (Scanalytics Inc.) and Decyder (GE Healthcare UK Ltd. Buckinghamshire, UK), all commercially available.

The proteins contained in each detected spot can be identified by a mass spectrometer. However, the following method can be used as a simpler method.

In advance, a sample containing the same protein is subjected to separation by two-dimensional gel electrophoresis under the same conditions, to prepare a reference gel. The proteins contained in each spot of the reference gel are identified and the information of the image data of reference gel and the identified proteins is stored as a reference data (a reference map). The identification of the proteins contained in each spot is conducted by in-gel digestion using an enzyme such as trypsin or the like and analysis of the obtained peptide mixture using a mass spectrometer. The reference map and the actual image data of gel obtained by electrophoresis are compared and matched with each other, whereby the proteins contained in each spot of the gel can be identified. The image analysis soft usable is, for example, the above-mentioned commercial PDQuest, GELLAB II+ and Decyder.

In the identification using a mass spectrometer, however, it is not necessary to identify the kind of post-translational modifications. It is sufficient to clarify whether or not, in a series of continuous spots on the gel, considered to be formed from an original protein, the proteins contained in each spot are derived from the same protein. Incidentally, in-depth analysis of protein modifications can be conducted by a known method such as identification of modification site using a mass spectrometer.

As described above, each of a series of spots on gel is measured for its signal intensity to conduct quantitative determination of proteins of each spot. Then, the signal intensity of each spot is divided by the signal intensity of vehicle control group to calculate a corrected signal intensity. Thereafter, there is calculated, between one protein and its modified protein or between modified proteins of different modifications, formed from the protein, a ratio of corrected signal intensities (a ratio of expression amounts) of two spots.

As the signal intensity of each spot, there can be used any of the peak height, area and volume of the signal of each spot.

An example of the method of calculation of the ratio of corrected signal intensities between modified proteins is explained below on a case that, after two-dimensional gel electrophoresis, an original protein α₁ and its modified protein α₂ have been detected. The signal intensities of α₁ and α₂ in vehicle control group are named α_{1c} and α_{2c}, respectively; and the signal intensities of α₁ and α₂ in chemical X dosed group are named α₁ₓ and α₂ₓ, respectively. In the X dosed group, the ratio of corrected signal intensities between modified proteins α₁ and α₂ is represented, for example, by the following formula (i) using a logarithm as an operator.

log₂(α₂ₓ/α_{2c})−log₂(α₁ₓ/α_{1c}) (i)

Here, when there is no change in the proportions of α₁ and α₂ between the X dosed group and the vehicle control group, the value α₁ₓ/α_{1c} and the value α₂ₓ/α_{2c} are equal, and the value of (i) becomes 0 (zero). In this case, the chemical X is estimated to show no stimulus to living organisms. Conversely, when there is a difference in the proportions of α₁ and α₂ between the X dosed group and the vehicle control group, the absolute value of (i) increases. In this case, the chemical X is estimated to show stimulus to living organisms.

In the above example of calculation method, a case was described in which one modified protein is formed from one protein. However, a ratio of corrected signal intensities can be calculated as well, also for a case in which two or more modified proteins are formed from one protein.

In the present invention, the production proportions of one protein and modified proteins formed therefrom are comprehensively compared between a chemical dosed group (the effect of the chemical on living organisms are known) and a test chemical dosed group. In this comparison between the chemical dosed group and the test chemical dosed group, there is calculated, in each group, a ratio of corrected signal intensities of a pair of one protein and a modified protein derived therefrom or a pair of modified proteins both derived formed from the protein, and the ratios of the two groups are compared.

When the signal intensities of α₁ and α₂ in the test chemical (E) dosed group are named α_{1E} and α_{2E}, respectively, the corrected signal intensities of α₁ and α₂ are α_{1E}/α_{1c} and α_{2E}/α_{2c}, respectively. Therefore, the comparison of ratios of corrected signal intensities is conducted between the ratio (α_{2X}/α_{2c})/(α_{1X}/α_{1c}) of corrected signal intensities of the chemical X dosed group and the ratio (α_{2E}/α_{2c})/(α_{1E}/α_{1c}) of corrected signal intensities of the test chemical E dosed group.

The number of pairs used for the comparison of the ratios of corrected signal intensities between the chemical dosed group and the test chemical dosed group is at least one, preferably at least five, more preferably at least 10. In the comparison, it is desired to select a pair which has a significant difference statistically between the group to which a chemical having an effect on living organisms has been administered and the group to which a chemical having no effect on living organisms has been administered. Each pair used for the comparison may include two or more pairs selected from a plurality of spots derived from an original protein. Predicting an effect on living organisms is conducted by using the difference in expression amounts of modified protein pairs selected from the test chemical dosed group by a statistical method, for example, score method, SVM method, cluster analysis or decision tree.

Incidentally, for example, when the vehicle used in preparation of each solution is one same vehicle or when the effect of vehicle is negligible, the signal intensity of vehicle control group need not be considered. In this case, the signal intensity ratios between α₁ and α₂ [for example, log₂(α₂ₓ/α_{1X}) and log₂(α_{2E}/α_{1E})] may be compared between the chemical X dosed group (the effect of X on living organisms is known) and the test chemical E dosed group.

The above explanation has been made on a case in which comparison is made on the signal intensity ratio between two spots derived from one protein or on the ratio of corrected signal intensities between the spots. In the present invention, it is possible to select three or more spots derived from one protein and, from their signal intensity ratios or their ratios of corrected signal intensities, calculate three or more production proportions of one protein or modified proteins simultaneously for comparison.

### EXAMPLES

### Example 1

### (1) Two-Dimensional Gel Electrophoresis of Comparative Sample and Control Sample

Each of the chemicals shown in Tables 1 to 3 was dissolved in a vehicle to prepare respective solutions. The name, CAS No., and carcinogenicity of each chemical, the vehicle used for each chemical, and the amount of each chemical administered to experimental animal are shown in Tables 1 to 3.

### [Table 1]

TABLE 1

| | | | | Amount |
|---|---|---|---|---|
| | | | | administered |
| Name of substance | CAS No. | Solvent | Carcinogenicity | (mg/kg/day) |
| Clofibrate | 637-07-0 | Corn oil | + | 250 |
| Di(2-ethylhexyl)phthalate | 117-81-7 | Corn oil | + | 300 |
| Carbon tetrachloride | 56-23-5 | Corn oil | + | 50 |
| 2,4-Diaminotoluene | 95-80-7 | Water | + | 10 |
| Quinoline | 91-22-5 | Corn oil | + | 25 |
| Phenobarbital | 50-06-6 | Water | + | 100 |
| Diethylnitrosamine | 55-18-5 | Water | + | 20 |
| 2-Nitropropane | 79-46-9 | Corn oil | + | 40 |
| N-nitrosomorpholine | 59-89-2 | Water | + | 10 |
| Aldrin | 309-00-2 | Corn oil | + | 0.3 |
| Di(2-ethylhexyl)adipate | 103-23-1 | Corn oil | + | 1000 |
| Ethinylestradiol | 57-63-6 | Corn oil | + | 0.5 |
| Hexachlorobenzene | 118-74-1 | Corn oil | + | 5 |
| α-Hexachlorocyclohexane | 319-84-6 | Corn oil | + | 20 |
| Trichloroethylene | 79-01-6 | Corn oil | + | 700 |
| Butylated hydroxyanisole | 25013-16-5 | Corn oil | + | 750 |
| Safrole | 94-59-7 | Corn oil | + | 300 |
| 1,4-Dichlorobenzene | 106-46-7 | Corn oil | + | 300 |
| 1,4-Dioxane | 123-91-1 | Water | + | 1000 |
| Furan | 110-00-9 | Corn oil | + | 10 |
| Methyl carbamate | 598-55-0 | Water | + | 500 |
| Thioacetamide | 62-55-5 | Water | + | 20 |
| N-nitrsodimethylamine | 62-75-9 | Water | + | 0.2 |

### [Table 2]

TABLE 2

| | | | | Amount |
|---|---|---|---|---|
| | | | | administered |
| Name of substance | CAS No. | Solvent | Carcinogenicity | (mg/kg/day) |
| 2-Amino-3,8-dimethylimidazo[4,5-f]- | 77500-04-0 | 1 w/v % CMCNa | + | 20 |
| quinoxaline | | | | |
| 2-Amino-1-methyl-6- | 105650-23-5 | 1 w/v % CMCNa | + | 5 |
| phenylimidazo[4,5-b]-pyridine | | | | |
| Benz(a)anthracene | 56-55-3 | Corn oil | + | 50 |
| 7,12-Dimethylbenzanthracene | 57-97-6 | Corn oil | + | 1 |
| 3-Methylcholantrene | 56-49-5 | Corn oil | + | 2 |
| 4-Nitroquinoline-1-oxide | 56-57-5 | Corn oil | + | 2 |
| N-ethy-N-nitrosourea | 759-73-9 | Water | + | 3 |
| Trichloroacetic acid | 76-03-9 | Water | + | 300 |
| Urethane | 51-79-6 | Water | + | 80 |
| Pentachloroethane | 76-01-7 | Corn oil | + | 200 |
| Chloroform | 67-66-3 | Corn oil | + | 90 |
| Benzo(a)pyrene | 50-32-8 | Corn oil | + | 15 |
| N-methyl-N′-nitro-N-nitrosoguanidine | 70-25-7 | Water | + | 0.5 |
| Tetrachloroethylene | 127-18-4 | Corn oil | + | 100 |
| Acetamide | 60-35-5 | Water | + | 1180 |
| Diethylstilbestrol | 56-53-1 | Corn oil | + | 10 |
| Phenytoin sodium | 57-41-0 | Water | + | 160 |
| D,L-ethionin | 67-21-0 | Corn oil | + | 30 |
| 4-Dimethylaminoaxobenzene | 60-11-7 | Corn oil | + | 50 |
| Chlorendic acid | 115-28-6 | Water | + | 100 |
| 2,6-Diaminotoluene | 823-40-5 | Water | − | 10 |
| 8-Hydrxyquinoline | 148-24-3 | Corn oil | − | 25 |
| D-mannitol | 69-65-8 | Water | − | 1000 |

### [Table 3]

TABLE 3

| | | | | Amount |
|---|---|---|---|---|
| | | | | administered |
| Name of substance | CAS No. | Solvent | Carcinogenicity | (mg/kg/day) |
| L-ascorbic acid | 50-81-7 | Water | − | 1000 |
| 2-Chloroethanol | 107-07-3 | Water | − | 1000 |
| 2-(Chloromethyl)pyridine | 6959-47-3 | Water | − | 150 |
| hydrochloride | | | | |
| DL-menthol | 89-78-1 | Corn oil | − | 1000 |
| 4-Nitro-o-phenylenediamine | 99-56-9 | 1 w/v % CMCNa | − | 250 |
| Benzoin | 119-53-9 | 5.0 w/v % | − | 500 |
| | | aqueous acacia | | |
| | | solution | | |
| Iodoform | 75-47-8 | Corn oil | − | 200 |
| Lithocholic acid | 434-13-9 | 5.0 w/v % | − | 1000 |
| | | aqueous acacia | | |
| | | solution | | |
| 2-Chloro-p-phenylenediamine sulfate | 61702-44-1 | 1 w/v % CMCNa | − | 100 |
| p-Phenylenediamine dihydrochloride | 624-18-0 | Water | − | 60 |
| 2,5-Toluenediamine sulfate | 6369-59-1 | 1 w/v % CMCNa | − | 50 |
| Aspirin | 50-78-2 | Corn oil | − | 27 |
| 4-(Chloroacetyl)acetanilide | 140-49-8 | Corn oil | − | 250 |
| Phthalamide | 88-96-0 | Corn oil | − | 1000 |
| Caprolactam | 105-60-2 | Water | − | 375 |
| 1-Chloro-2-propanol | 127-00-4 | Water | − | 100 |
| 3-Chloro-p-toluidine | 95-74-9 | Corn oil | − | 300 |
| Glutaraldehyde | 111-30-8 | Water | − | 50 |
| 4-Nitroanthranylic acid | 619-17-0 | Corn oil | − | 1000 |
| 1-Nitronaphthalene | 86-57-7 | Corn oil | − | 100 |

5-Weeks old male rats (F344, SPF strain) obtained from Charles River Laboratories Japan Inc. were divided into groups each consisting of three rats. To the rats of each chemical dosed group was forcibly administered orally a solution obtained by dissolving one of the chemicals shown in Tables 1 to 3, and to the rats of a vehicle control group was forcibly administered orally only a vehicle. The administration was conducted once a day for 28 days. On the 29th day from the start of administration, the liver of each rat was collected. A fragment was cut out from each liver and stored at −20° C. The protein collected from each rat was determined quantitatively by the Bradford method. Then, to the comparative sample collected from the chemical dosed group, the control sample collected from the vehicle control group, and a pool sample (which was a mixture of the comparative sample and the control sample) were added, at 0° C., Cy5, Cy3 and Cy2 (DMF solution, 1 ml) each of 200 pmol per 100 g of protein, and a labeling reaction was allowed to take place on ice for 30 minutes. After the completion of the reaction, an excessive amount of a Lysine solution (10 mM Lysis buffer solution, 1 ml) was added, followed by storage for 10 minutes to complete the reaction. Further, a x2 sample buffer [8 M urea, 4% (w/v) CHAPS, 20 mg/ml DTT, 2% (v/v) Pharmalytes] of same volume was added, followed by storage on ice for 10 minutes.

Then, the mixture of the resulting samples or each resulting sample was individually subjected to two-dimensional gel electrophoresis.

First-dimensional electrophoresis was conducted in Multiphor II (GE Helthcare Uk Ltd. Buckinghamshire, UK) using IPG (Immobilized pH Gradient) Strips (24 cm, pI3-10L) (GE Helthcare UK Ltd. Buckinghamshire, UK). A sample (100 mg of protein) was added from a cup loading holder. Focussing was conducted by 40 kVh in total. After the electrophoresis, equilibration was made for 10 minutes each using a solution A obtained by adding 0.25% (w/v) of DTT to an equilibrating solution (50 mM Tris, pH 8.8, 6 M urea, 30% glycerol, 2% SDS) and a solution B obtained by adding 4.5% (w/v) of iodoacetamide to the equilibrating solution. Successively, second-dimensional electrophoresis was conducted in an Ettan DALT II system (GE Helthcare UK Ltd. Buckinghamshire, UK) using a self-made 12% uniform gel sandwiched between low-fluorescent glasses. Migration was conducted at 3 W (15° C.) overnight.

### (2) Analysis of Two-Dimensional Gel Electrophoresis Gels of Comparative Sample and Control Sample

For each gel after migration, image capture was immediately conducted using Master Imager (GE Helthcare UK Ltd. Buckinghamshire, UK), at a wavelength corresponding to each Cy. The excitation wavelengths of Cy5, Cy3 and Cy2 were set at 625 nm, 480 nm and 425 nm, respectively, and their fluorescence wavelengths were set at 680 nm, 540 nm and 480 nm, respectively.

In the case of the sample obtained by mixing before electrophoresis, the recognition of spots of captured image and the quantitative determination and comparison between Cys in one gel were conducted using Decyder-DIA Soft (GE Helthcare UK Ltd. Buckinghamshire, UK). The matching of spots with the reference map of rat liver protein (2-D data base formed in-house by identifying rat liver 724 spots) was conducted using Decyder-BVA soft (GE Helthcare UK Ltd. Buckinghamshire, UK). When each sample after Cy labeling was independently subjected to electrophoresis, the quantitative determination of each spot and the matching of spots were conducted using PDQuest (Bio-Rad Laboratories, Inc.).

### (3) Preparation of Reference Map

In order to prepare a reference map, identification of spots using a mass spectrometer was conducted according to the following procedure.

### (a) Preparation of Gel for Mass Spectrometry

First-dimensional electrophoresis was conducted in Multiphor II (GE Helthcare UK Ltd. Buckinghamshire, UK) using IPG (Immobilized pH Gradient) Strips (24 cm, pI3-10L) (GE Helthcare UK Ltd. Buckinghamshire, UK). A sample (protein) was added from a cup loading holder. Focussing was conducted by 40 kVh in total. After the electrophoresis, equilibration was conducted for 10 minutes each using a solution A obtained by adding 0.25% (w/v) of DTT to an equilibrating solution (50 mM Tris, pH 8.8, 6 M urea, 30% glycerol, 2% SDS) and a solution B obtained by adding 4.5% (w/v) of iodoacetamide to the equilibrating solution. After the equilibration, second-dimensional electrophoresis was conducted in an Ettan DALT II system (GE Helthcare UK Ltd. Buckinghamshire, UK) using a self-made 12% uniform gel sandwiched between low-fluorescent glasses. Migration was conducted at 3 W (15° C.) overnight.

### (b) Enzymatic Digestion

The gel plug obtained by picking was subjected to enzymatic digestion (room temperature, one night) with trypsin (Promega UK, Southampton, Hants, UK). The peptide fragments obtained by the digestion were extracted from inside the gel using an aqueous acetonitrile solution

(acetonitrile/water/formic acid=50/45/5).

(c) Separation of Peptides and their Identification by Mass Spectrometry

Separation of peptides was conducted by liquid chromatography (Waters Corporation, Milford, Mass., USA) fitted with L-column. The separated peptides were subjected to MS/MS using an ESI (electrospray ionization) type mass spectrometer (Micromass, Manchester, UK), for use in identification of proteins. The separation by liquid chromatography and the MS/MS by mass spectrometer were conducted under the conditions shown below. Using Mascot (Matrix Science, London, UK) as a software for MS data analysis, the MS/MS data obtained were compared with public data base such as NCBInr or Swiss Prot to search relevant proteins.

### (4) Quantitative Determination and Comparison of Post-Translational Modifications, Truncation, Etc. of Particular Proteins Detected by Two-Dimensional Gel Electrophoresis

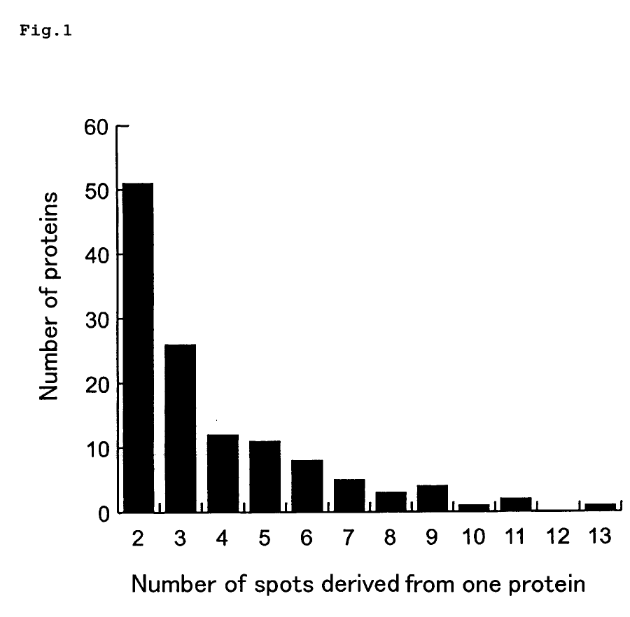

In the rat liver reference map obtained by identification using a mass spectrometer, the kinds of proteins detected from one protein as a plurality of spots were 127. The relation between the number of spots detected from one protein and the number of proteins in each spot is shown in FIG. 1.

For the spots of the 127 proteins and their modified proteins, there was calculated a base 2 logarithm [log₂(αₓ/α_{c})] of the ratio (αₓ/α_{c}) of the expression amount (αₓ) of the comparative sample and the expression amount (α_{c}) of the control sample. Then, a difference in logarithms was calculated between spots derived from one protein. The calculation of difference in logarithms was made for all combinations of spots derived from one protein.

For a case in which N-nitromorpholine was administered as a chemical, there are shown, in Table 4, names of 10 proteins which were top-tanked in difference (as absolute value) in logarithms log₂(αₓ/α_{c}), Nos. which are given to these proteins in data base NCBInr or Swiss Prot, and spot Nos. used in calculation of the absolute value. Incidentally, the spot Nos. are numbers given to all 2743 spots observed in two-dimensional gel electrophoresis, in order from the acidic, high-molecular spot side of reference gel to its basic, low-molecular spot side.

### [Table 4]

TABLE 4

| | | SWISS- | |
|---|---|---|---|
| | | PROT No. | Difference of |
| Name of protein | Spot No. | or NCBInr NO. | log₂(αₓ/α_{c}) |
| Heat shock protein 60 kDa | 941-974 | P19227 | 1.910 |
| ATP synthase alpha chain | 1064-1096 | P15999 | 1.824 |
| Non-muscle type caldesmon | 628-654 | Q62736 | 1.618 |
| Cytoskeleton I type | 1174-1447 | Q63279 | 1.451 |
| keratin-19 | | | |
| RIKEN cDNA 0610010D20 | 1708-1753 | gi\|34865395 | 1.349 |
| Cytoskeleton II type | 1068-1481 | Q10758 | 1.344 |
| keratin-8 | | | |
| MAWD binding protein | 2032-2036 | gi\|51491893 | 1.256 |
| Transketorase | 789-813 | gi\|12018252 | 1.074 |
| Carbonate dehydrogenase III | 2098-2113 | P14141 | 1.038 |
| Hydroxyglutaryl-CoA | 1215-1216 | P22791 | 0.948 |
| synthase | | | |

### (5) Prediction of Carcinogenicity by Score Method

Preparation of a formula for carcinogenicity prediction by a score method was conducted according to the following procedure.

(a) For total 68 chemicals shown in Tables 1 to 3 (44 carcinogenic chemicals and 24 non-carcinogenic chemicals) and for 127 kinds of proteins detected as a plurality of spots from one protein, there were calculated, according to the method described in (3), differences in base 2 logarithms [log₂(αₓ/α_{c})] of the ratios of expression amounts of comparative sample and control sample, for all combinations of a plurality of spots.
(b) From these differences in base 2 logarithms, those having a significant difference statistically between carcinogenic chemical group and non-carcinogenic chemical group were selected based on the t value of Welch. Here, when there were a plurality of pairs of modified proteins derived from one original protein, only the data of the modified protein pair which gave the largest t value of Welch, was left (used). Therefore, with respect to the data used in prediction of carcinogenicity, only one spot set was used from one original protein. The differences in logarithms were divided into the following three categories to which a score −1, 0 or 1 was assigned.
1: The difference in logarithms is larger than X.
0: The difference in logarithms is not smaller than −X but not larger than X.
−1: The difference in logarithms is smaller than −1.

Incidentally, X was set at a value at which the final prediction rate became highest.

(c) In the differences in logarithms, accumulation of scores was made in each of the measured carcinogenic chemical group and the non-carcinogenic chemical group, and respective scores of the carcinogenic chemical group and the non-carcinogenic chemical group were calculated.

When the score of carcinogenic chemical group was smaller than the score of non-carcinogenic chemical group, the score of the post-translational modification data of relevant protein was multiplied by −1, whereby, for all post-translational modification data, the score of non-carcinogenic chemical group was allowed to be smaller than the score of carcinogenic chemical group.

(d) In the prediction of carcinogenicity for all chemicals by the present score method, a chemical giving a total score larger than 0 (zero) when the scores of selected post-translational modification data are accumulated, was judged to be a carcinogenic chemical, and a chemical giving a total score of 0 (zero) or smaller was judged to be a non-carcinogenic chemical.
(e) Until the highest prediction rate was obtained, the threshold value of (b) and the number of post-translational modification data set were adjusted and the operation of (a) to (d) was repeated.

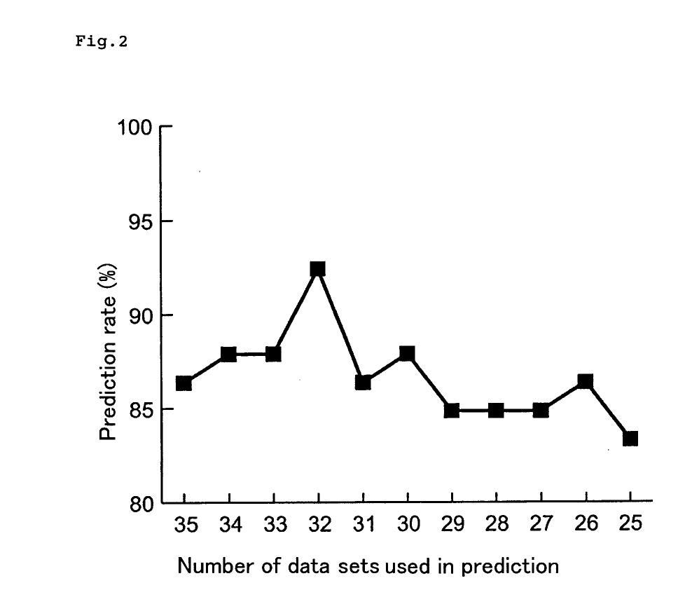

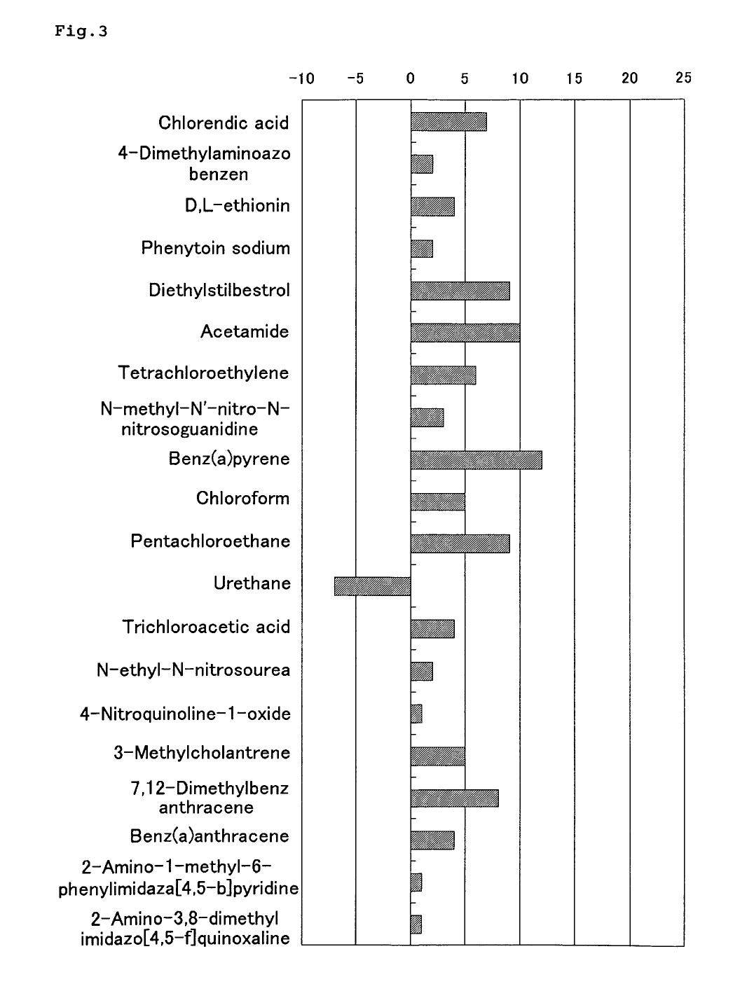

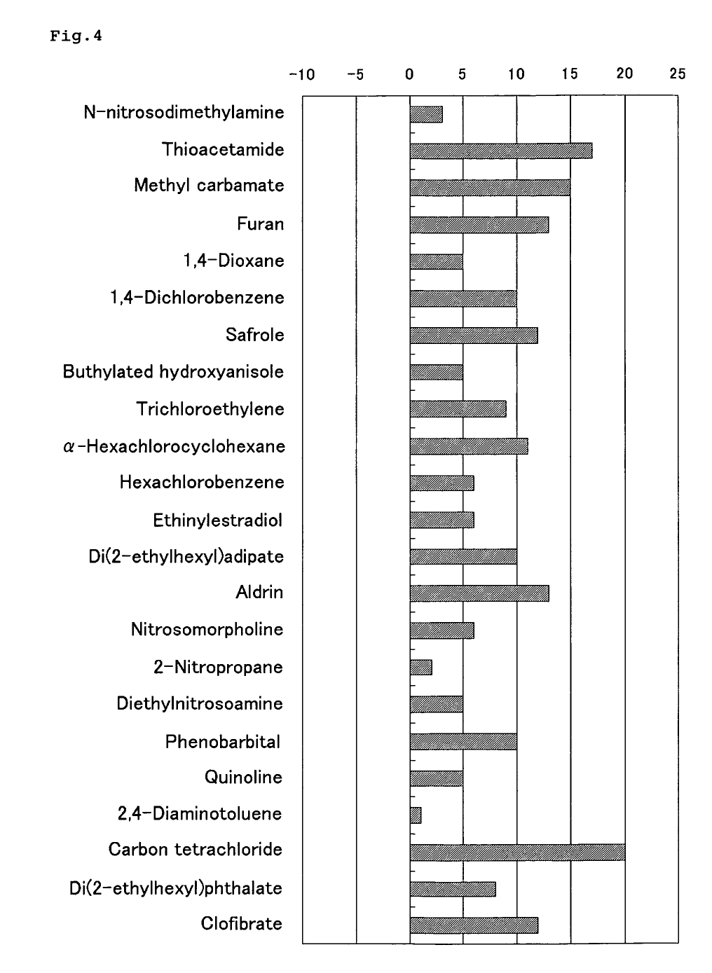

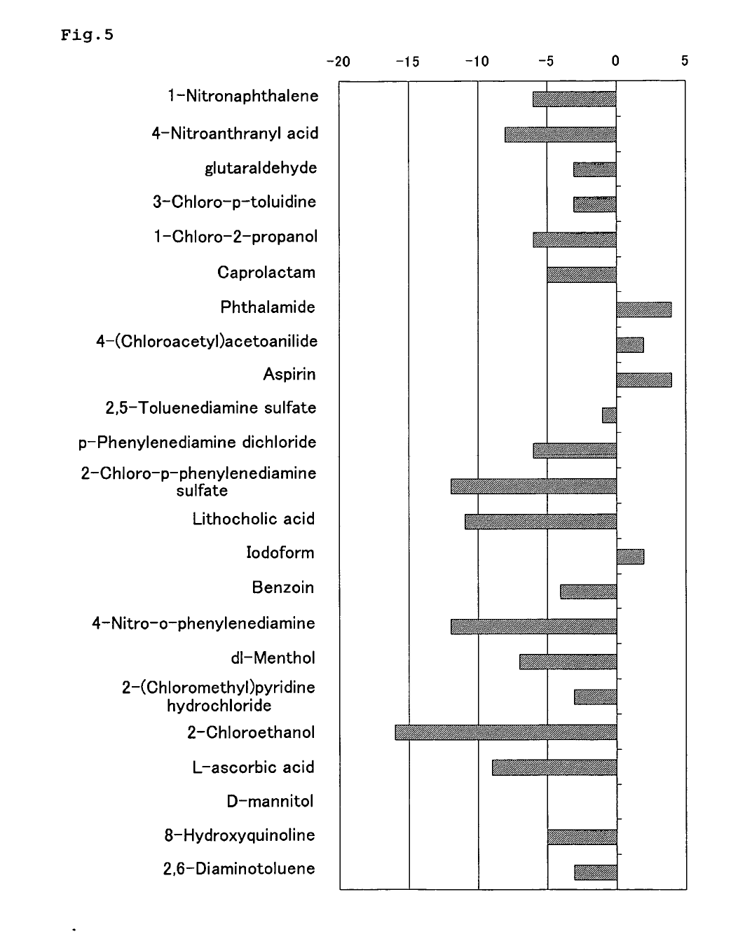

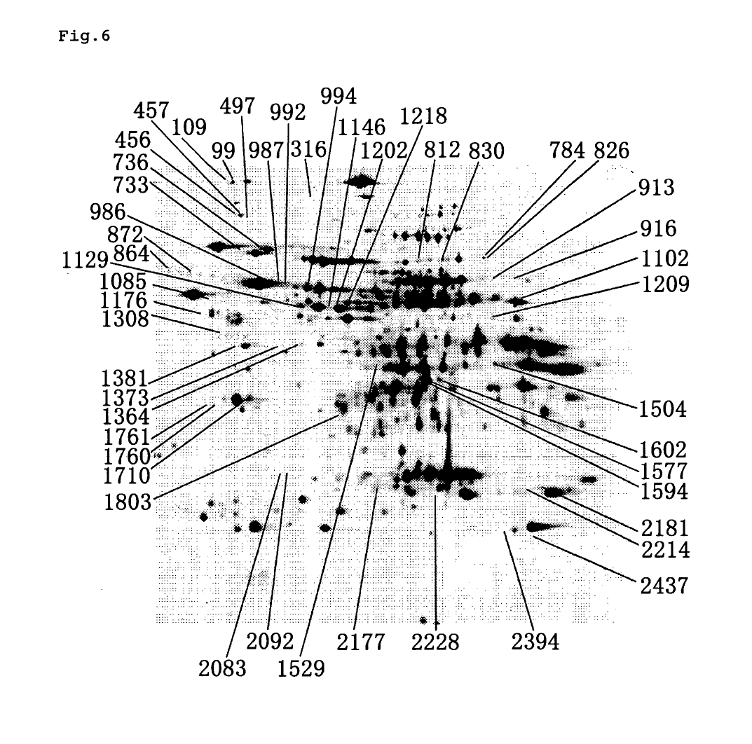

The above operation of (a) to (e) was conducted for total 68 chemicals (44 carcinogenic chemicals and 24 non-carcinogenic chemicals) and the spot sets giving the highest prediction rate were selected. In FIG. 2 and Table 5 are shown the number of data sets and the prediction rate obtained therefor. In FIGS. 3 to 5 are shown total scores of carcinogenic chemicals and non-carcinogenic chemicals when the 32 sets giving the highest prediction rate were used. In Tables 6 and 7 are shown the names of proteins of 32 sets which gave the highest prediction rate, Nos. of the spots used for prediction and the t values of Welch; and in FIG. 6 are shown the positions on reference gel, of 32 sets. Incidentally, in FIG. 6, each numeral indicating each spot via a connection line is a spot No. of each spot.

The verification of effectiveness of the present score method was made by predicting the carcinogenicities of carcinogenic chemicals and non-carcinogenic chemicals used for selection of sets used in score calculation, according to the leave-one-out method which is a validation method. Data sets were selected using 67 chemicals (a test set) which is total 68 chemicals (a training set) of carcinogenic chemicals and non-carcinogenic chemicals minus any one chemical. Using each data set, there was conducted cross-validation for prediction of the carcinogenicity of the one chemical excluded above. In this case, the prediction rate of test set was 89.4%.

### [Table 5]

TABLE 5

| Number of sets of | |
|---|---|
| post-translational | Prediction |
| modification data | rate (%) |
| 45 | 89.39 |
| 40 | 90.91 |
| 35 | 86.36 |
| 34 | 87.88 |
| 33 | 87.88 |
| 32 | 92.42 |
| 31 | 86.36 |
| 30 | 87.88 |
| 29 | 84.85 |
| 28 | 84.85 |
| 27 | 84.85 |
| 26 | 86.36 |
| 25 | 83.33 |
| 20 | 84.85 |
| 15 | 80.30 |
| 10 | 81.82 |
| 9 | 81.82 |
| 8 | 80.30 |
| 7 | 80.30 |
| 6 | 81.82 |
| 5 | 75.76 |
| 4 | 74.24 |
| 3 | 74.24 |
| 2 | 69.70 |
| 1 | 71.21 |

### [Table 6]

TABLE 6

| | | T value of |
|---|---|---|
| Name of protein | Spot No. | Welch |
| Glutamic acid dehydrogenase | 1118-1135 | 4.240 |
| Glutathione S transferase Mu 2 | 2177-2228 | 3.720 |
| Fructose-bisphosphate aldolase B | 1504-1539 | 3.366 |
| ATP synthase alpha chain | 1096-1102 | 3.248 |
| ATP synthase beta | 1085-1176 | 3.246 |
| choline dehydrogenase | 913-916 | 3.022 |
| Alfatoxin B1 aldehyde reductase 1 | 1594-1602 | 2.928 |
| Heat shock protein 60 kDa | 986-987 | 2.858 |
| Heat shock homologous protein 71 kDa | 733-736 | 2.728 |
| Alginase 1 | 1529-1577 | 2.717 |
| Contrapsin-like protease inhibitor 1 | 864-872 | 2.692 |
| [Precursor] | | |
| Glucose-regulated protein 78 kDa | 682-689 | 2.618 |
| Alpha enolase | 1202-1218 | 2.575 |
| Glutathione S transferase Yb-1 | 2181-2214 | 2.562 |
| Betaine-homocysteine S-methyl group | 1362-1391 | 2.479 |
| transferase | | |
| Ribosome-binding protein 1 (ribosome | 497-316 | 2.416 |
| receptor protein) (mRRp) | | |
| Methylmalonic acid semialdehyde | 1077-1124 | 2.372 |
| dehydrogenase [acylation] | | |
| Aldehyde dehydrogenase | 1129-1146 | 2.372 |
| Succinyl-CoA ligase beta chain | 1364-1373 | 2.362 |

### [Table 7]

TABLE 7

| | | T value of |
|---|---|---|
| Name of protein | Spot No. | Welch |
| valosine-containing protein | 456-457 | 2.355 |
| Protein disulfide isomerase A3 | 992-994 | 2.352 |
| hypoxia up-regulated 1 | 99-109 | 2.337 |
| Cytoskeleton II type keratin-8 | 1308-1381 | 2.326 |
| Peroxiredoxin 1 | 2394-2437 | 2.319 |
| Ultra-long chain acyl CoA | 784-826 | 2.313 |
| dehydrogenase | | |
| Hydroxymethylglutaryl CoA synthase | 1209-1216 | 2.289 |
| Senescence marker protein-30 | 1710-1760 | 2.258 |
| Transketolase | 812-830 | 2.199 |
| Proteasome-activated complex subunit 1 | 2083-2092 | 2.198 |
| Catalase | 936-944 | 2.131 |
| Eucaryote translation and elongation | 1803-1761 | 2.093 |
| factor 1 delta | | |
| Carbonate dehydrogenase III | 2087-2105 | 2.093 |

### Example 2

### Prediction of Carcinogenicity Using Support Vector Machine (SVM)

Prediction of carcinogenicity by SVM was conducted using the differences in logarithms, obtained in (1) to (3) of Example 1. Preparation of a carcinogenicity prediction formula was conducted according to the following procedure.

(a) Post-translational modification data showing characteristic changes were selected based on the t value of Welch between carcinogenic chemical group and non-carcinogenic chemical group.

A carcinogenicity prediction formula was prepared according to the following procedure, using Support Vector Machine (SVM). As the SVM, there was used a free soft, SVMlight (obtained from URL http://svmlight.joachims.org/). Using the selected post-translational modification data sets and the SVMlight, learning was conducted under the following conditions, to prepare a prediction formula.

Conditions: Linear was used as the Kernel option. A biased hyperplane was used as the hyperplane used for separation.
(b) In order to verify the effectiveness of the prediction formula, there were conducted carcinogenicity prediction of the carcinogenic chemical group and non-carcinogenic chemical group (training set) used for preparation of the prediction formula, and cross-validation of chemical by leave one out.
(c) The procedure of (a) to (b) was repeated until the post-translational modification data set showing the highest prediction rate was obtained.

A carcinogenicity prediction formula was prepared according to the procedure of (a) to (c). A highest prediction rate of 80.3% in the training set was obtained when top-ranked (in the t value of Welch) 25 sets were used. The prediction results are shown in Tables 8 to 11. The prediction rate of the test set obtained for verification was 77.3%.

### [Table 8]

TABLE 8

| | | Prediction |
|---|---|---|
| | | result*^{1,}*³ |
| Name of substance | Carcinogenicity*² | (training set) |
| Clofibrate | + | +1 CORRECT |
| Di(2-ethylhexyl) phthalate | + | +1 CORRECT |
| Carbon tetrachloride | + | +1 CORRECT |
| 2,4-Diaminotoluene | + | +1 CORRECT |
| Quinoline | + | +1 CORRECT |
| Phenobarbital | + | +1 CORRECT |
| Diethylnitrosamine | + | +1 CORRECT |
| 2-Nitropropane | + | +1 CORRECT |
| N-nitrosomorpholine | + | +1 CORRECT |
| Aldrin | + | +1 CORRECT |
| Di(2-ethylhexyl) adipate | + | +1 CORRECT |
| Ethinylestradiol | + | +1 CORRECT |
| Hexachlorobenzene | + | +1 CORRECT |
| α-Hexachlorocyclohexane | + | +1 CORRECT |
| Trichloroethylene | + | +1 CORRECT |
| Butylated hydroxyanisole | + | −1 |
| Safrole | + | +1 CORRECT |
| 1,4-Dichlorobenzene | + | +1 CORRECT |
| 1,4-Dioxane | + | +1 CORRECT |
| Furan | + | +1 CORRECT |

### [Table 9]

TABLE 9

| | | Prediction |
|---|---|---|
| | | result*^{1,}*³ |
| Name of substance | Carcinogenicity*² | (training set) |
| Methyl carbamate | + | +1 CORRECT |
| Thioacetamide | + | +1 CORRECT |
| N-nitrsodimethylamine | + | −1 |
| 2-Amino-3,8- | + | +1 CORRECT |
| dimethylimidazo[4,5-f]- | | |
| quinoxaline | | |
| 2-Amino-1-methyl-6- | + | +1 CORRECT |
| phenylimidazo[4,5-b]- | | |
| pyridine | | |
| Benz(a)anthracene | + | +1 CORRECT |
| 7,12-Dimethylbenzanthracene | + | +1 CORRECT |
| 3-Methylcholantrene | + | +1 CORRECT |
| 4-Nitroquinoline-1-oxide | + | +1 CORRECT |
| N-ethy-N-nitrosourea | + | +1 CORRECT |
| Trichloroacetic acid | + | +1 CORRECT |
| Urethane | + | +1 CORRECT |
| Pentachloroethane | + | +1 CORRECT |
| Chloroform | + | +1 CORRECT |
| Benzo(a)pyrene | + | +1 CORRECT |
| N-methyl-N′-nitro-N- | + | +1 CORRECT |
| nitrosoguanidine | | |
| Tetrachloroethylene | + | +1 CORRECT |
| Acetamide | + | +1 CORRECT |
| Diethylstilbestrol | + | +1 CORRECT |

### [Table 10]

TABLE 10

| | | Prediction |
|---|---|---|
| | | result*^{1,}*³ |
| Name of substance | Carcinogenicity*² | (training set) |
| Phenytoin sodium | + | +1 CORRECT |
| D,L-ethionin | + | +1 CORRECT |
| 4-Dimethylaminoaxobenzene | + | +1 CORRECT |
| Chlorendic acid | + | −1 |
| 2,6-Diaminotoluene | + | +1 CORRECT |
| 8-Hydrxyquinoline | − | −1 |
| D-mannitol | − | −1 CORRECT |
| L-ascorbic acid | − | 1 |
| 2-Chloroethanol | − | 1 |
| 2-(Chloromethyl)pyridine | − | −1 CORRECT |
| hydrochloride | | |
| DL-menthol | − | −1 CORRECT |
| 4-Nitro-o-phenylenediamine | − | −1 CORRECT |
| Benzoin | − | −1 CORRECT |
| Iodoform | − | −1 CORRECT |
| Lithocholic acid | − | −1 CORRECT |
| 2-Chloro-p-phenylenediamine | − | 1 |
| sulfate | | |
| p-Phenylenediamine | − | −1 CORRECT |
| dihydrochloride | | |
| 2,5-Toluenediamine sulfate | − | −1 CORRECT |
| Aspirin | − | −1 CORRECT |
| 4-(Chloroacetyl)acetanilide | − | −1 CORRECT |

### [Table 11]

TABLE 11

| | | Prediction |
|---|---|---|
| | | result*^{1,}*³ |
| Name of substance | Carcinogenicity*² | (training set) |
| Phthalamide | − | 1 |
| Caprolactam | − | 1 |
| 1-Chloro-2-propanol | − | 1 |
| 3-Chloro-p-toluidine | − | 1 |
| Glutaraldehyde | − | −1 CORRECT |
| 4-Nitroanthranylic acid | − | 1 |
| 1-Nitronaphthalene | − | 1 |

*¹A prediction result of training set when top-ranked (in the t value of Welch) 25 sets of post-translational modification data were used. Prediction rate: 80.8%
*²+ indicates carcinogenic chemical, and − indicates non-carcinogenic chemical.
*³+1 CORRECT and −1 CORRECT indicates the correctly predicted compounds, carcinogenic chemical was predicted as carcinogenic chemical, non-carcinogenic chemical was predicted as non-carcinogenic chemical. −1 and 1 indicates the incorrectly predicted compounds, non-carcinogenic chemical was predicted as carcinogenic chemical, carcinogenic chemical was predicted as non-carcinogenic chemical.

### Example 3

### Prediction of Pathologic Findings

Pathologic findings was predicted using digital data of post-translational modifications. The prediction was conducted according to the following procedure.

(a) Extraction of Post-Translational Modifications which is Characteristic in Occurrence of Hypertrophy of Liver Cell

Post-translational modification data showing characteristic changes were selected based on the t value of Welch, between 10 chemicals with which pathology of liver cell hypertrophy was seen in the liver after 28 days repeated administration [Clofibrate, di(2-ethylhexyl)phthalate, phenobarbital, hexachlorobenzene, aαhexachlorocyclohexane, safrole, 1,4-dichlorobenzene, furan, dl-menthol and iodoform] and 20 chemicals with which no pathology of liver cell hypertrophy was seen [carbon tetrachloride, 2,4-diaminotoluene, quinoline, diethylnitrosamine, 2-nitropropane, N-nitrosomorpholine, aldrin, di(2-ethylhexyl)adipate, ethinilestradiol, trichloroethylene, butylated hydroxyanisole, 1,4-dioxane, methyl carbamate, 2,6-diaminotoluene, 8-hydroxyquinoline, D-mannitol, L-ascorbic acid, 2-chloroethanol, 2-(chloromethyl)pyridine hydrochloride and 4-nitro-o-phenylenediamine].

### (b) Preparation of Prediction Formula Using SVM

A formula for diagnosis of liver cell hypertrophy was prepared according to the following procedure, using Support Vector Machine (SVM). As the SVM, there was used a free soft, SVMlight (obtained from URL http://svmlight.joachims.org/). Using the selected post-translational modification data sets and the SVMlight, learning was conducted under the following conditions, to prepare a prediction formula.

Conditions: Linear was used as the Kernel option. A biased hyperplane was used as the hyperplane used for separation.
(c) In order to verify the effectiveness of the diagnosis formula, there were conducted diagnosis of liver cell hypertrophy of the carcinogenic chemical group and non-carcinogenic chemical group (training set) used for preparation of the diagnosis formula, and cross-validation of chemical by leave one out.
(d) The procedure of (a) to (c) was repeated until the post-translational modification data set showing the highest concordance of diagnosis was obtained.

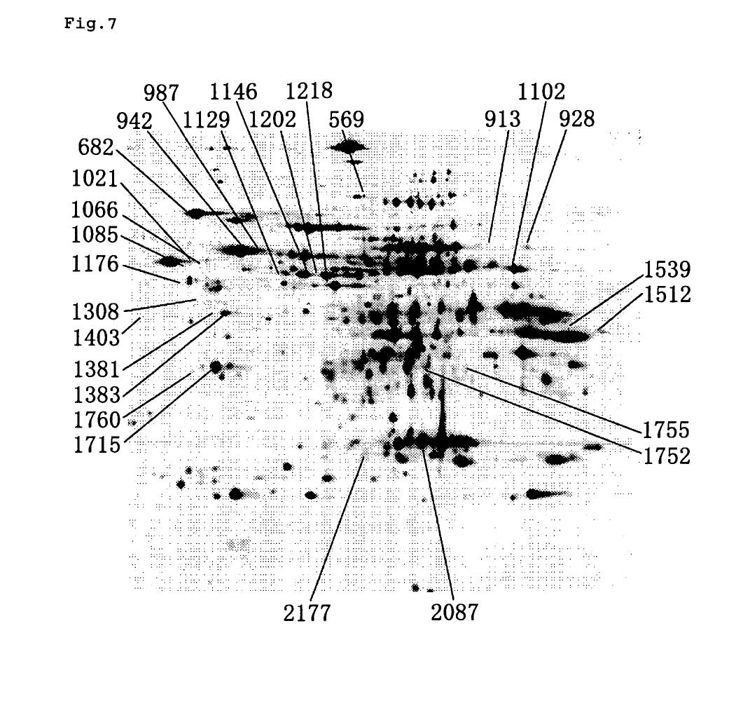

A prediction formula of liver cell hypertrophy was prepared according to the procedure of (a) to (d). A highest concordance of 90.0% in the training set was obtained when top-ranked (in the t value of Welch) 20 sets were used. In Table 12 are shown Nos. of spots used in preparation of prediction formula, names of proteins of the spots, and t values of Welch. In FIG. 7 are shown the positions on gel, of the spots used. The prediction results are shown in Table 13. The concordance of the test set used for verification was 86.7%. From these results, it has become clear that the present invention allows for prediction of effect of test chemical on living organisms.

### [Table 12]

TABLE 12

| Name of protein | Spot No. | t value |
|---|---|---|
| Cytoskeleton actin 2 | 1383-1403 | 6.235 |
| Heat shock protein 60 kDa | 942-987 | 5.955 |
| ATP synthase alpha chain | 1100-1102 | 4.573 |
| Fructose-bisphosphate aldolase B | 1504-1539 | 4.483 |
| choline dehydrogenase | 913-928 | 4.431 |
| Glutamic acid dehydrogenase | 895-1135 | 3.948 |
| RIKEN cDNA 0610010 D20 | 1752-1755 | 3.371 |
| Alpha-1-anti-proteinase | 1021-1066 | 3.228 |
| Glucose-regulated protein 78 kDa | 682-1495 | 3.216 |
| Cytoskeleton II type keratin-8 | 1308-1381 | 2.987 |
| Senescence marker protein-30 | 1715-1760 | 2.922 |
| Carbonate dehydrogenase III | 2087-2105 | 2.897 |
| Catalase | 936-944 | 2.887 |
| Glyceraldehyde-3-phosphoric acid | 1653-1657 | 2.855 |
| dehydrogenase | | |
| Aspartate aminotransferase | 1450-1512 | 2.814 |
| Dimethylglycine dehydrogenase | 479-569 | 2.776 |
| Aldehyde dehydrogenase | 1129-1146 | 2.681 |
| Glutathione S-transferase Mu 2 | 2177-2226 | 2.616 |
| ATP synthase beta subunit | 1085-1176 | 2.597 |
| Alpha enolase | 1202-1218 | 2.542 |

### [Table 13]

TABLE 13

| | Finding of | |
|---|---|---|
| | hepatocyte | Prediction |
| Chemical | hypertrpy*² | result*^{1,}*³ |
| Clofibrate | + | +1 CORRECT |
| Di(2-ethylhexyl) phthalate | + | −1 |
| Phenobarbital | + | +1 CORRECT |
| Hexachlorobenzene | + | +1 CORRECT |
| α-Hexachlorocyclohexane | + | +1 CORRECT |
| Safrole | + | +1 CORRECT |
| 1,4-Dichlorobenzene | + | +1 CORRECT |
| Furan | + | −1 |
| dl-Menthol | + | +1 CORRECT |
| Iodoform | + | +1 CORRECT |
| Carbon tetrachloride | − | −1 CORRECT |
| 2,4-Diaminotoluene | − | −1 CORRECT |
| Quinoline | − | −1 CORRECT |
| Diethylnitrosamine | − | −1 CORRECT |
| 2-Nitropropane | − | −1 CORRECT |
| N-nitrosomorpholine | − | −1 CORRECT |
| Aldrin | − | −1 CORRECT |
| Di(2-ethylhexyl) adipate | − | 1 |
| Ethinylestradiol | − | −1 CORRECT |
| Trichloroethylene | − | −1 CORRECT |
| Butylated hydroxyanisole | − | −1 CORRECT |
| 1,4-Dioxane | − | −1 CORRECT |
| Methyl carbamate | − | −1 CORRECT |
| 2,6-Diaminotoluene | − | −1 CORRECT |
| 8-Hydroxyquinoline | − | −1 CORRECT |
| D-mannitol | − | −1 CORRECT |
| L-ascorbic acid | − | −1 CORRECT |
| 2-Chloroethanol | − | −1 CORRECT |
| 2-(Chloromethyl)pyridine | − | −1 CORRECT |
| hydrochloride | | |
| 4-Nitro-o-phenylenediamine | − | −1 CORRECT |

*¹A prediction result of training set when top-ranked (in the t value of Welch) 20 sets (shown in Table 6) of post-translational modification data shown were used. Prediction rate: 90.0%
*²+ indicates occurrence of liver cell hypertrophy, and − indicates no occurrence of liver cell hypertrophy.
*³+1 CORRECT and −1 CORRECT indicates the correctly predicted or diagnosed the occurrence and not occurrence of liver cell hypertrophy. −1 and 1 indicates the incorrectly predicted compounds.

1. A method of predicting an effect of a test chemical on living organisms, which comprises:
a step of administering a plurality of chemicals whose effects on living organisms are known, to respective chemical dosed groups, collecting proteins from each chemical dosed group after a definite period of time, separating the proteins by two-dimensional gel electrophoresis, measuring signal intensities of at least two spots selected from a plurality of spots of one separated protein and one or more separated modified proteins thereof formed by post-translational modifications or by truncation, calculating a signal intensity ratio of the at least two spots, and accumulating such a signal intensity ratio,
a step of administering a test chemical to a test chemical dosed group, collecting proteins from the test chemical dosed group after a definite period of time, separating the proteins by two-dimensional gel electrophoresis, measuring signal intensities of at least two spots selected from a plurality of spots of one separated protein and one or more separated modified proteins thereof formed by post-translational modifications or by truncation, and calculating a signal intensity ratio of the at least two spots, and
a step of comparing at least one signal intensity ratio calculated in the test chemical dosed group, with the signal intensity ratio calculated from the spots of the corresponding protein or the modified proteins thereof in each chemical dosed group.

2. A method of predicting an effect of a test chemical on living organisms, which comprises:
a step of administering a vehicle to a vehicle control group, collecting proteins from the vehicle control group after a definite period of time, separating the proteins by two-dimensional gel electrophoresis, and measuring signal intensities (α_{c}) of at least two spots selected from a plurality of spots of one separated protein and one or more separated modified proteins thereof formed by post-translational modifications or by truncation,
a step of dissolving a plurality of chemicals whose effect on living organisms are known, in said vehicle to prepare chemical solutions, administering the chemical solutions to respective chemical dosed groups, collecting proteins from each chemical dosed group after a definite period of time, separating the proteins by two-dimensional gel electrophoresis, measuring signal intensities (αₓ) of at least two spots selected from a plurality of spots of one separated protein and one or more separated modified proteins thereof formed by post-translational modifications or by truncation, dividing, for each of the plurality of spots, the signal intensity (αₓ) by the signal intensity (α_{c}) of vehicle control group to calculate a corrected signal intensity (αₓ/α_{c}), calculating a ratio of corrected signal intensities (αₓ/α_{c}) between the at least two spots selected from a plurality of spots, and accumulating such a ratio,
a step of dissolving a test chemical in said vehicle to prepare a test chemical solution, administering the test chemical solution to a test chemical dosed group, collecting proteins from the test chemical dosed group after a definite period of time, separating the proteins by two-dimensional gel electrophoresis, measuring, for at least two spots selected from a plurality of spots of at least one separated protein and one or more separated modified proteins thereof formed by post-translational modifications or by truncation, their signal intensities (α_{E}), dividing, for each of the plurality of spots, the signal intensity (α_{E}) by the signal intensity (α_{c}) of vehicle control group to calculate a corrected signal intensity (α_{E}/α_{c}), and calculating a ratio of corrected signal intensities (α_{E}/α_{c}) between the at least two spots selected from a plurality of spots, and
a step of comparing at least one ratio of corrected signal intensities (α_{E}/α_{c}) calculated in the test chemical dosed group, with the ratio of corrected signal intensities (αₓ/α_{c}) calculated from the spots of the corresponding protein or the modified proteins thereof in each chemical dosed group.

3. A method of predicting an effect of a test chemical on living organisms according to claim 2, wherein, in the step of comparing the ratio of corrected signal intensities calculated in the test chemical dosed group, with the ratio of corrected signal intensities calculated in each chemical dosed group, the comparison of the ratios of corrected signal intensities between the test chemical dosed group and the chemical dosed group is conducted by dividing the chemical dosed group into at least two groups based on the effect of chemical on living organisms, making a significant test between the groups to select a modified protein formed by characteristic modifications, and using the corrected signal intensity of the modified protein in the comparison.

4. A method of predicting an effect of a test chemical on living organisms according to any of claims 1 to 3, wherein the effect on living organisms is carcinogenicity, drug effect or toxicity.
